(19) United States
(12) Patent Application Publication
(10) Pub. No.: US 2023/0325635 A1
(43) Pub. Date: Oct. 12, 2023

(54) CONTROLLING AGENTS USING RELATIVE VARIATIONAL INTRINSIC CONTROL

(71) Applicant: DeepMind Technologies Limited, London (GB)

(72) Inventors: David Constantine Patrick Warde-Farley, Quebec (CA); Steven Stenberg Hansen, London (GB); Volodymyr Mnih, Toronto (CA); Kate Alexandra Baumli, London (GB)

(21) Appl. No.: 18/025,304

(22) PCT Filed: Sep. 10, 2021
(86) PCT No.: PCT/EP2021/074892

§ 371 Date: Mar. 8, 2023

Related U.S. Application Data
(60) Provisional application No. 63/076,876, filed on Sep. 10, 2020.

(51) Int. Cl. G06N 3/045; G06N 3/08

(52) U.S. Cl. CPC G06N 3/045; G06N 3/08

(57) ABSTRACT

Methods, systems, and apparatus, including computer programs encoded on a computer storage medium, for training a policy neural network for use in controlling an agent using relative variational intrinsic control. In one aspect, a method includes: selecting a skill from a set of skills; generating a trajectory by controlling the agent using the policy neural network while the policy neural network is conditioned on the selected skill; processing an initial observation and a last observation using a relative discriminator neural network to generate a relative score; processing the last observation using an absolute discriminator neural network to generate an absolute score; generating a reward for the trajectory from the absolute score corresponding to the selected skill and the relative score corresponding to the selected skill; and training the policy neural network on the reward for the trajectory.

### BACKGROUND

This specification relates to controlling agents using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that trains a policy neural network that is used to control an agent. In particular, the system trains the policy neural network so that the policy neural network can be used to control the agent to perform a set of skills in an unsupervised manner, e.g., using only intrinsic rewards.

The subject matter described in this specification can be implemented in particular embodiments so as to realize one or more of the following advantages.

In the absence of external rewards, agents can still learn useful behaviors by identifying and mastering a set of diverse skills within their environment. Existing skill learning methods use mutual information objectives to incentivize each skill to be diverse and distinguishable from the rest. However, applying these existing skill learning methods can result in trivially diverse skill sets, e.g., skills that are distinguishable only in the last state of the trajectory generated by performing the skills. However, the final state of a skill should depend on the initial state, i.e., on the context in which it is performed. To ensure useful skill diversity, this specification discloses techniques that make use of skill learning objective, relative variational intrinsic control (RVIC), which incentivizes learning skills that are distinguishable in how they change the agent's relationship to its environment. The resulting set of skills tiles the space of affordances available to the agent and are more useful for downstream applications than skills discovered by existing methods, e.g., when being repurposed for use in hierarchical reinforcement learning for tasks that have external rewards.

Compared to conventional systems, the system described in this specification may consume fewer computational resources (e.g., memory and computing power) by training the policy neural network to achieve an acceptable level of performance over fewer training iterations. For example, hierarchical agents using pre-trained relative variational intrinsic control skill-conditioned policies can achieve a higher level of performance than hierarchical agents using pre-trained skill policies discovered by existing skill learning methods. Moreover, a set of one or more policy neural networks trained by the system described in this specification can select actions that enable the agent to accomplish tasks more effectively (e.g., more quickly) than a policy neural network trained by an alternative system. As described above, the learned skills can be more generalizable, and hence more readily composed to accomplish a task.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example policy neural network system.

FIG. 2 shows an example architecture of relative variational intrinsic control (RVIC).

FIG. 3 is a flow diagram of an example process for controlling agents using relative variational intrinsic control.

Like reference numbers and designations in the various drawings indicate like elements.

### DETAILED DESCRIPTION

This specification describes approaches to training a policy neural network.

The policy neural network is configured to receive a policy input that includes an observation characterizing a state of an environment and data identifying a skill and generate a policy output (e.g., a probability distribution over a set of possible actions) used in controlling an agent interacting with the environment to cause the agent to carry out the identified skill. Specifically, training the policy neural network incentivizes learning a set of skills that is diverse in how each skill changes the agent's relationship to the environment, by making use of a skill learning objective that is referred to as relative variational intrinsic control (RVIC). Thus, during the training, a policy output of the policy neural network is used to determine actions that are used for controlling the agent. As described later, in general, a “skill” comprises a sequence of actions performed by the agent in the environment.

In some implementations, the environment is a real-world environment and the agent is a mechanical agent interacting with the real-world environment. For example, the agent may be a robot interacting with the environment to accomplish a specific task, e.g., to locate an object of interest in the environment or to move an object of interest to a specified location in the environment or to navigate to a specified destination in the environment; or the agent may be an autonomous or semi-autonomous land or air or sea vehicle navigating through the environment.

In these implementations, the observations may include, for example, one or more of images, object position data, and sensor data to capture observations as the agent as it interacts with the environment, for example sensor data from an image, distance, or position sensor or from an actuator.

For example in the case of a robot the observations may include data characterizing the current state of the robot, e.g., one or more of: joint position, joint velocity, joint force, torque or acceleration, for example gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In the case of an electronic agent the observations may include data from one or more sensors monitoring part of a plant or service facility such as current, voltage, power, temperature and other sensors and/or electronic signals representing the functioning of electronic and/or mechanical items of equipment.

In these implementations, the actions may be control inputs to control the robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation such as steering, and movement, e.g., braking and/or acceleration of the vehicle.

In some implementations the environment is a simulated environment and the agent is implemented as one or more computers interacting with the simulated environment. Training an agent in a simulated environment may enable the agent to learn from large amounts of simulated training data while avoiding risks associated with training the agent in a real world environment, e.g., damage to the agent due to performing poorly chosen actions. An agent trained in a simulated environment may thereafter be deployed in a real-world environment.

For example the simulated environment may be a simulation of a robot or vehicle and the reinforcement learning system may be trained on the simulation. For example, the simulated environment may be a motion simulation environment, e.g., a driving simulation or a flight simulation, and the agent is a simulated vehicle navigating through the motion simulation. In these implementations, the actions may be control inputs to control the simulated user or simulated vehicle.

In another example, the simulated environment may be a video game and the agent may be a simulated user playing the video game.

In a further example the environment may be a chemical synthesis or a protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions selected by the system automatically without human interaction. The observations may include direct or indirect observations of a state of the protein and/or may be derived from simulation.

In a similar way the environment may be a drug design environment such that each state is a respective state of a potential pharma chemical drug and the agent is a computer system for determining elements of the pharma chemical drug and/or a synthetic pathway for the pharma chemical drug. The drug/synthesis may be designed based on a reward derived from a target for the drug, for example in simulation. As another example, the agent may be a mechanical agent that performs or controls synthesis of the drug.

In some applications, the agent may be a static or mobile software agent i.e., a computer programs configured to operate autonomously and/or with other software agents or people to perform a task. For example, the environment may be an integrated circuit routing environment and the system may be configured to learn to perform a routing task for routing interconnection lines of an integrated circuit such as an ASIC. The rewards (or costs) may then be dependent on one or more routing metrics such as an interconnect resistance, capacitance, impedance, loss, speed or propagation delay, physical line parameters such as width, thickness or geometry, and design rules. The observations may be observations of component positions and interconnections; the actions may comprise component placing actions, e.g., to define a component position or orientation and/or interconnect routing actions, e.g., interconnect selection and/or placement actions. The routing task may thus comprise placing components i.e., determining positions and/or orientations of components of the integrated circuit, and/or determining a routing of interconnections between the components. Once the routing task has been completed an integrated circuit, e.g., ASIC, may be fabricated according to the determined placement and/or routing. Or the environment may be a data packet communications network environment, and the agent be a router to route packets of data over the communications network based on observations of the network.

Generally, in the case of a simulated environment, the observations may include simulated versions of one or more of the previously described observations or types of observations and the actions may include simulated versions of one or more of the previously described actions or types of actions.

In some other applications the agent may control actions in a real-world environment including items of equipment, for example in a data center or grid mains power or water distribution system, or in a manufacturing plant or service facility. The observations may then relate to operation of the plant or facility. For example the observations may include observations of power or water usage by equipment, or observations of power generation or distribution control, or observations of usage of a resource or of waste production. The agent may control actions in the environment to increase efficiency, for example by reducing resource usage, and/or reduce the environmental impact of operations in the environment, for example by reducing waste. The actions may include actions controlling or imposing operating conditions on items of equipment of the plant/facility, and/or actions that result in changes to settings in the operation of the plant/facility e.g., to adjust or turn on/off components of the plant/facility.

In some further applications, the environment is a real-world environment and the agent manages distribution of tasks across computing resources e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In general, in the above described applications, where the environment is a simulated version of a real-world environment, once the system/method has been trained in the simulation it may afterwards be applied to the real-world environment. That is, control signals generated by the system/method may be used to control the agent to perform a task in the real-world environment in response to observations from the real-world environment. Optionally the system/method may continue training in the real-world environment based on one or more rewards from the real-world environment.

Optionally, in any of the above implementations, the observation at any given time step may include data from a previous time step that may be beneficial in characterizing the environment, e.g., the action performed at the previous time step, the reward received at the previous time step, and so on.

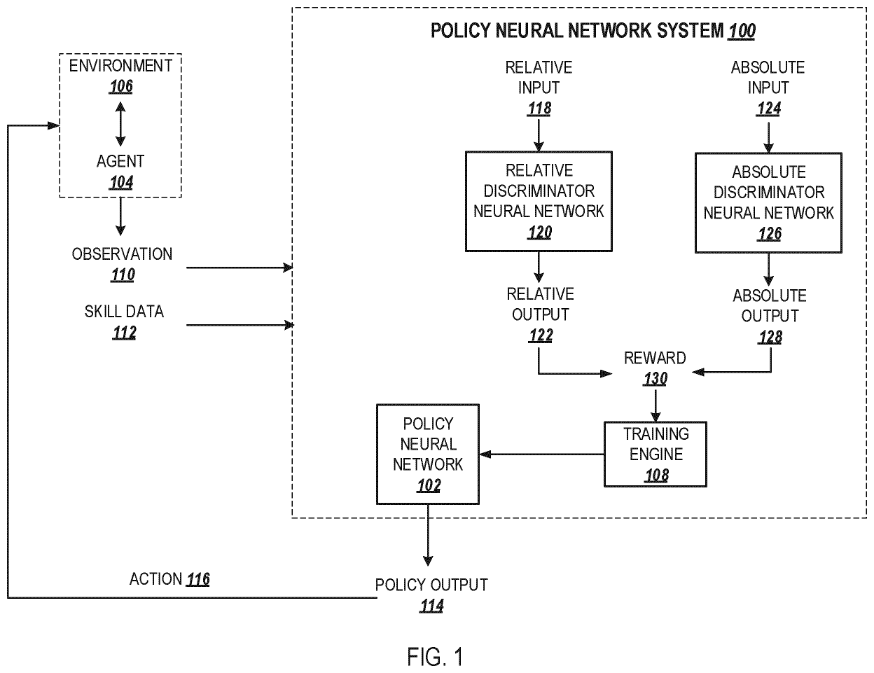

FIG. 1 shows an example policy neural network system 100. The policy neural network system 100 is an example of a system implemented as computer programs on one or more computers in one or more locations in which the systems, components, and techniques described below are implemented.

The policy neural network system 100 uses a policy neural network 102 to control an agent 104 interacting with an environment 106 by selecting actions 116 to be performed by the agent 104 at each of multiple time steps.

Each input to the policy neural network 102 can include an observation 110 characterizing the state of the environment being interacted with by the agent 104 and the output of the policy neural network (“policy output” 114) can define an action 116 to be performed by the agent 104 in response to the observation 110.

As a particular example, the output of the policy neural network 102 can be a respective Q value for each action in the set of actions that represents a predicted return, i.e., a predicted time-discounted sum of future rewards, that would be received by the agent as a result of performing the action in response to the observation.

The system 100 can then control the agent 104 based on the Q values for the actions in the set of actions, e.g., by selecting, as the action to be performed by the agent 104, the action with the highest Q value.

As another particular example, each input to the policy neural network 102 can be an observation and the output of the policy neural network 102 can be a probability distribution over the set of actions, with the probability for each action representing the likelihood that performing the action in response to the observation will maximize the predicted return. The system 100 can then control the agent 104 based on the probabilities, e.g., by selecting, as the action to be performed by the agent 104, the action with the highest probability or by sampling an action from the probability distribution. As another particular example, the policy output may directly define the action to be performed, i.e., the policy neural network 102 may output the policy output that defines a single action.

In some cases, in order to allow for fine-grained control of the agent, the system 100 can treat the space of actions to be performed by the agent, i.e., the set of possible control inputs, as a continuous space. Such settings are referred to as continuous control settings. In these cases, the output of the policy neural network 102 can be the parameters of a multi-variate probability distribution over the space, e.g., the means and covariances of a multi-variate Normal distribution.

At each time step while controlling the agent 104, the system 100 receives an observation 110 characterizing the current state of the environment 106 at the time step and data identifying a skill (also referred as a skill data 112, or simply a “skill”) from a set of skills.

The skill data 112 indicates a skill from a set of skills. A “skill” as used in this specification is a behavior that is performed by the agent 104 as a result of the agent 104 performing a sequence of actions 116 in response to successive observations 110. At the beginning of training the policy neural network 102, the behaviors will generally be random or close to random and may not be different from one another. As training progresses, however, because of the way that the system 100 trains the policy neural network 102, the behaviors will generally become different, e.g., will modify the state of the environment in different ways when starting from a given starting state. That is, conditioning the policy neural network on a given skill 112, e.g., by providing the policy neural network 102 policy inputs that include data identifying the given skill 112, and using the policy output 114 will result in a different set of actions 116 being performed by the agent 104 than conditioning the policy neural network 102 on a different skill from the set of skills.

The set of skills can be finite or infinite. When the set of skills is finite, the skill data 112 can be, e.g., a one-hot vector identifying the given skill or a dense embedding identifying the given skill. When the set of skills is infinite, the skill data 112 can be a point, e.g., a vector from a continuous space that represents the set of skills.

The system 100 uses a training engine 108 to train the policy neural network 102 (e.g., to learn a set of skills that are distinguishable in how they change the agent 104's relationship to the environment 106).

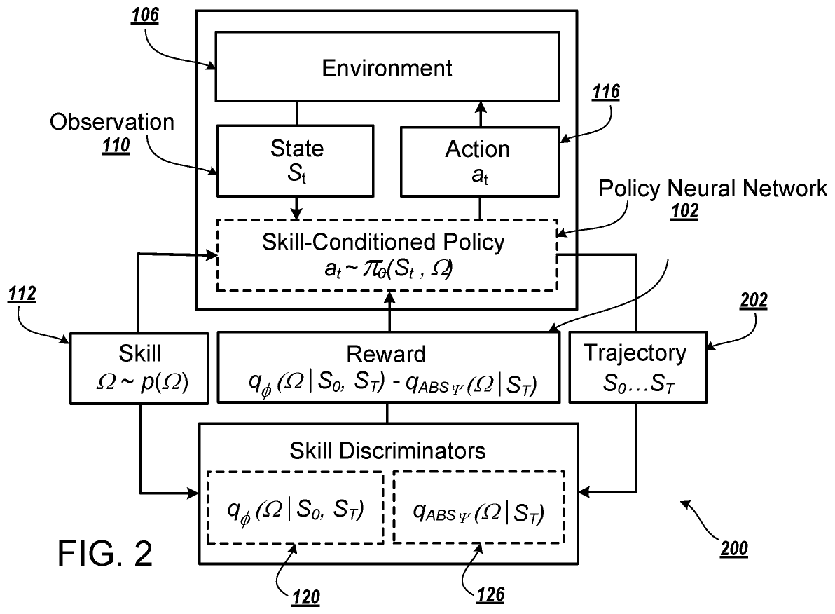

During the training, the training engine 108 repeatedly uses the policy neural network 102 to generate trajectories. Each trajectory includes a sequence of received observations 110 that were received while the agent 104 interacts with the environment 106 while being controlled by the policy neural network conditioned on a given selected skill 112. Trajectory data is described in more details referring to FIG. 2.

The training engine 108 then trains the policy neural network 102 on the generated trajectories. In some cases, the engine 108 trains the policy neural network 102 on-policy, i.e., immediately uses the generated trajectories for training so that a given trajectory that is being used for training was generated by the current version of the policy neural network 102. In some other cases, the engine 108 trains the policy neural network 102 off-policy, i.e., stores generated trajectories in a memory and then trains the policy neural network 102 on stored trajectories, so that a given trajectory that is being used for training may have been generated by an earlier version of the policy neural network 102.

To train the policy neural network on a given trajectory, the training engine 108 uses a relative discriminator neural network 120 and an absolute discriminator neural network 126. In general terms, in implementations, during the training the policy neural network, each of these discriminator neural networks is also trained, in particular to predict the selected skill.

The relative discriminator neural network 120 is configured to process a relative input 118 that includes the initial observation in the sequence of observations in the given trajectory and the last observation in the sequence to generate a relative output 122 that includes a respective relative score corresponding to each skill in the set of skills. Each relative score represents an estimated likelihood that the policy neural network 102 was conditioned on the corresponding skill while the trajectory data was generated. In implementations, during the training of the policy neural network 102, the training engine 108 also trains the relative discriminator neural network 120 by optimizing an objective function that encourages the relative score corresponding to the actual selected skill to be increased, i.e., that encourages the relative discriminator neural network 120 to more accurately generate relative outputs 122. For example, the objective function may be a log-likelihood or other objective that measures the relative score corresponding to the actual selected skill.

The absolute discriminator neural network 126 is configured to process an absolute input 124 that includes the last observation in the sequence (and not the initial observation in the sequence) to generate an absolute output 128 that includes a respective absolute score corresponding to each skill in the set of skills. Each absolute score represents an estimated likelihood that the policy neural network 102 was conditioned on the corresponding skill while the trajectory data was generated. During the training of the policy neural network, the training engine 108 trains the absolute discriminator neural network 126 by optimizing an objective function that encourages the absolute score corresponding to the selected skill to be increased, i.e., that encourages the absolute discriminator neural network 126 to more accurately generate absolute outputs 128. For example, the objective function may be a log-likelihood or other objective that measures the absolute score corresponding to the actual selected skill.

In some implementations, the relative input 118 includes the first N observations in the sequence of observations in the given trajectory and the last N observations in the sequence, where N is a pre-defined constant. In these implementations, the absolute input 124 includes the last N observations in the sequence.

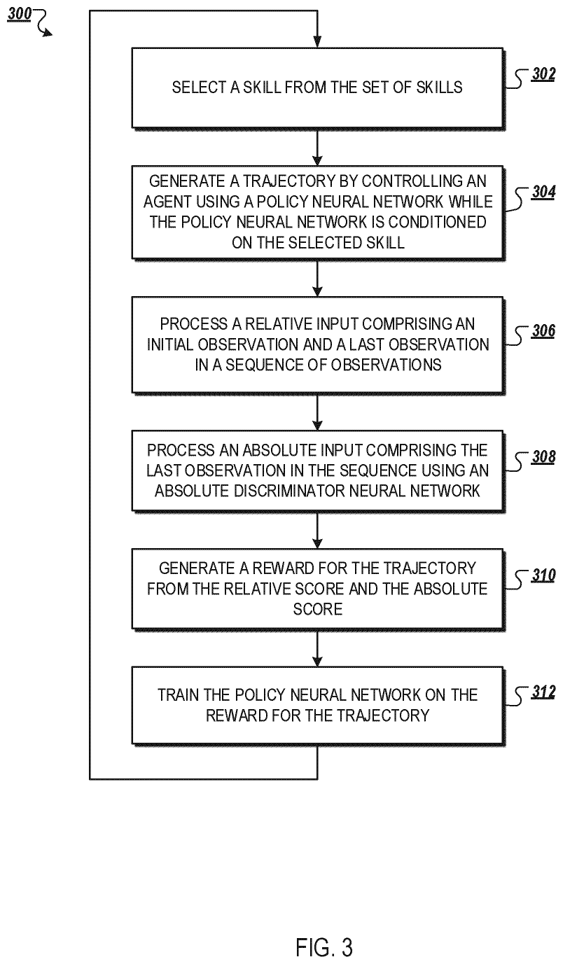

When training on a given trajectory, the training engine 108 generates a reward 130 based on the relative output 122 and the absolute output 128, e.g., from a difference between the absolute score and the relative score Generating the reward 130 from the relative output 122 and the absolute output 128 will be described in more detail below with reference to FIGS. 2 and 3.

The training engine 108 then uses the reward 130 to train the policy neural network 102.

In particular, the training engine 108 trains the policy neural network 102 on the reward 130 to maximize time discounted expected rewards for generated trajectory data through reinforcement learning.

Training the policy neural network on rewards will be described in more detail below with reference to FIGS. 2 and 3.

Once the policy neural network 102 has been trained to allow the agent 104 to perform the set of skills in the environment 106, the system 100 or another system can then use the trained policy neural network to control the agent 104 by causing the agent 104 to perform the skills in the environment 106, e.g., to explore the environment without needing any extrinsic rewards.

Alternatively or in addition, the system 100 or another system can train, e.g., through a hierarchical reinforcement learning technique, a controller neural network (“meta-controller”) that controls the agent 104 by selecting from a meta-action space that includes the set of skills and, optionally, primitive actions from the set of actions. The meta-controller can be trained on a specific task for which extrinsic rewards are available, allowing the learned skills to be re-purposed to improve the learning of the task. In other words, in response to a given observation, the meta-controller can be used to select from a set of “meta-actions” that includes the learned skills or, in some cases, some or all of the set of actions. When the meta-controller selects a skill, the agent will be controlled by the trained policy neural network conditioned on the selected skill, e.g., for a fixed number of time steps. When the meta-controller selects a primitive action, the agent will be controlled by performing the primitive action a single time in response to the current observation.

FIG. 2 shows an example architecture 200. The example architecture 200 is an example configuration of training the policy neural network 102 using the relative discriminator neural network 120 and the absolute discriminator neural network 126.

In the example architecture 200, the policy neural network 102 (illustrated as a “skill-conditioned policy”) receives the observation 110 and the data identifying the skill 112 as inputs.

In some implementations, the system 100 selects the skill from a discrete set. In some other implementations, the system selects the skill from a continuous space of skills. Selecting the skill will be described below with reference to FIG. 3.

The system 100 generates a trajectory 202 that includes a sequence of observations 110 (s₀, . . . , S_{T}) by controlling the agent using policy outputs generated by the policy neural network 102 while the policy neural network 102 is conditioned on the data identifying the skill 112 for a fixed number of steps, T. That is, at each time step tin the fixed number of time steps, the system receives an observation sₜ 110 and uses the policy neural network 102 conditioned on the data identifying the skill 112 to select an action at 116. The policy neural network 102 is called “skill-conditioned” because the policy neural network 102 receives the data identifying the skill 112 (Ω) as input.

The policy neural network 102 can have any appropriate architecture that allows the policy neural network 102 to process an observation and data identifying a skill to generate a policy output.

As a particular example, the policy neural network 102 can separately encode the observation and the data identifying the skill and then process a combination, e.g., a concatenation or a sum, of the encoded observation and the encoded skill to generate the policy output, e.g., by processing the combination through a multi-layer perceptron (MLP) or other set of one or more feed-forward layers. For example, the policy neural network 102 can encode the data identifying the skill by processing the data using an MLP.

When the observations include high-dimensional sensor data, e.g., images or laser data, the policy neural network can use a convolutional neural network to encode the observations. As another example, when the observations include only relatively lower-dimensional inputs, e.g., sensor readings that characterize the current state of a robot, the policy neural network can use a multi-layer perceptron to encode the observations. As yet another example, when the observations include both high-dimensional sensor data and lower-dimensional inputs, the policy neural network can include a convolutional encoder that encodes the high-dimensional data, a fully-connected encoder that encodes the lower-dimensional data, and a subnetwork that operates on a combination, e.g., a concatenation, of the encoded data to generate the encoded observation.

The example architecture 200 can include two skill discriminators, i.e., the relative discriminator neural network 120 (q_{ϕ}) and the absolute discriminator neural network 126 (q_{ψ}^{ABS}). Each skill discriminator can include one or more neural networks. The system 100 trains the two skill discriminators 120, 126 to predict the skill from the initial and last states (so, S_{T}) of the trajectory (for the case of the relative discriminator neural network 120) and only the last state (s_{T}) in the trajectory (for the case of the absolute discriminator neural network 126). The system 100 generates the reward 130 using the outputs of the two skill discriminators.

In some implementations, the reward is based on the difference between the probabilities assigned by two skill discriminators 120, 126 to the skill used to generate the trajectory. The system uses the reward to incentivize learning a set of skills that is diverse in how each skill changes the agent's relationship to the environment. Because the absolute discriminator only bases its predictions on the absolute state of the environment upon skill termination, the system trains the policy adversarially with the respect to the absolute discriminator. For example, the system rewards discriminability by q_{φ} while simultaneously punishing discriminability by q_{ψ}^{ABS}. For example, the system minimizes the difference between two skill discriminators 120, 126 by maximizing the reward 130 between the skills and the initial observation, given the final observation:

Reward=log q_{ϕ}(Ω|s_{T}, s₀)−log q_{ψ}^{ABS}(Ω|s_{T}), where q is a variational distribution defined by a respective discriminator neural network to infer the probability of skill Ω (other notations were previously described).

Each of the discriminator neural networks can have any appropriate architecture that allows the discriminator to map the corresponding input to the corresponding output.

In some implementations, the absolute discriminator neural network and the relative discriminator neural network share some parameters, e.g., a shared sub-neural network, neural network weights or layers. For example, the absolute discriminator neural network and the relative discriminator neural network can share an encoder neural network that generates encoded representations of received observations (e.g., the trajectory 202). The encoder neural network may be shared by using it in turn for the absolute discriminator neural network and the relative discriminator neural network.

In some implementations, when the observations include high-dimensional sensor data, e.g., images or laser data, the encoder neural network can encode the observations using a convolutional neural network. As another example, when the observations include only relatively lower-dimensional inputs, e.g., sensor readings that characterize the current state of a robot, the encoder neural network can encode the observations by using a multi-layer perceptron (MLP). As yet another example, when the observations include both high-dimensional sensor data and lower-dimensional inputs, the encoder neural network can include a convolutional encoder that encodes the high-dimensional data, a fully-connected encoder that encodes the lower-dimensional data, and a subnetwork that operates on a combination, e.g., a concatenation, of the encoded data to generate the encoded observation.

In these implementations, the absolute discriminator neural network includes an absolute decoder neural network, e.g., an MLP, configured to process the encoded representation of the last observation to generate the absolute output.

In these implementations, the relative discriminator neural network includes a relative decoder neural network, e.g., an MLP, that is configured to process a concatenation of the encoded representations of the initial observation and the last observation to generate the relative output.

FIG. 3 is a flow diagram of an example process 300 for training a policy neural network using relative variational intrinsic control. For convenience, the process 300 will be described as being performed by a system of one or more computers located in one or more locations. For example, a policy neural network system, e.g., the policy neural network system 100 of FIG. 1, appropriately programmed, can perform the process 300.

The system repeatedly performs the process 300 to train the policy neural network system. This training scheme can be referred to as a relative variational intrinsic control scheme, because the rewards generated are intrinsic, i.e., are generated without any external information about the quality of any given generated trajectory, and are based on a relative measure of change in the environment, i.e., based on both the relative and absolute discriminator neural network outputs, requiring the policy neural network to learn skills that change the environment in different, diverse ways.

The system selects a skill from the set of skills (302). In some implementations, the system samples a skill from a uniform probability distribution over the set of skills. As described above, the skill is a behavior that is performed by the agent as a result of the agent performing a sequence of actions, in response to successive observations.

The system generates a trajectory by controlling the agent using the policy neural network while the policy neural network is conditioned on the selected skill (304). The trajectory includes a sequence of observations received while the agent interacts with the environment while controlled using the policy neural network that is conditioned on the selected skill.

In some implementations, generating the trajectory starting from the last state of the environment for a preceding trajectory. That is, the system begins controlling the agent starting from the last state of the environment in the most recently generated trajectory and the initial observation in the trajectory characterizes the last state of the environment for the preceding trajectory.

In some other implementations, after generating each, the system determines whether criteria have been satisfied for resetting the environment, e.g., to a starting state for the agent to perform actions. For example, criteria can include entering a state that has been designated as a terminal state performance by the agent 104 of a threshold number of actions since the environment was most recently reset, or both. In response to determining that the criteria are satisfied after generating the preceding trajectory, the system selects a state of the environment from a set of possible initial states of the environment as an initial state for a next trajectory to be generated. In response to determining that the criteria are not satisfied, the system uses the last state of the preceding trajectory as the initial state of the trajectory.

The system then trains the policy neural network on the generated trajectory.

To train the policy neural network, the system processes a relative input using a relative discriminator neural network (306). The relative input includes the initial observation in the sequence, i.e., in the sequence of observations in the trajectory, and the last observation in the sequence. The relative discriminator neural network is configured to process the relative input to generate a relative output that includes a respective relative score corresponding to each skill in the set of skills, each relative score representing an estimated likelihood that the policy neural network was conditioned on the corresponding skill while the trajectory was generated. The system trains the relative discriminator neural network by optimizing an objective function that encourages the relative score corresponding to the selected skill to be increased.

The system processes an absolute input using an absolute discriminator neural network (308). The absolute input includes the last observation in the sequence (but not the initial observation in the sequence). The absolute discriminator neural network is configured to process the absolute input to generate an absolute output that includes a respective absolute score corresponding to each skill in the set of skills, each absolute score representing an estimated likelihood that the policy neural network was conditioned on the corresponding skill while the trajectory was generated. The system trains the absolute discriminator neural network by optimizing an objective function that encourages the absolute score corresponding to the selected skill to be increased.

The system generates a reward for the trajectory from the absolute score corresponding to the selected skill and the relative score corresponding to the selected skill (310). In some implementations, the reward is equal to or directly proportional to a difference between the relative score corresponding to the selected skill and the absolute score corresponding to the selected skill. In other implementations, the reward is equal to or directly proportional to a difference between a logarithm of the relative score corresponding to the selected skill and a logarithm of the absolute score corresponding to the selected skill.

The system trains the policy neural network on the reward for the trajectory (312). For the training, the system can either use the reward as a sparse reward for the trajectory, i.e., associate the reward only with the last observation in the trajectory, or as a dense reward for the trajectory, i.e., associate the reward (or a time-discounted version of the reward) with each observation in the trajectory.

In some implementations, training the policy neural network on the reward for the trajectory includes training the neural network to maximize time discounted expected rewards for generated trajectories.

The system can perform the training by, once a batch of rewards have been computed for a batch of trajectories, updating the values of the parameters of the policy neural network by performing an iteration of a reinforcement learning technique, e.g., an off-policy reinforcement learning technique, on the batch of trajectories and corresponding rewards. The system can use any appropriate off-policy reinforcement learning technique to perform the training, e.g., a Q-learning reinforcement learning technique, an actor-critic reinforcement learning technique, or a policy gradient based reinforcement learning technique.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for training a policy neural network for use in controlling an agent interacting with an environment, wherein the policy neural network is configured to receive a policy input comprising an input observation characterizing a state of the environment and data identifying a skill from a set of skills and to generate a policy output that defines a control policy for controlling the agent, the method comprising repeatedly performing operations comprising:
selecting a skill from the set of skills;
generating a trajectory by controlling the agent using the policy neural network while the policy neural network is conditioned on the selected skill, the trajectory comprising a sequence of observations received while the agent interacts with the environment while controlled using the policy neural network that is conditioned on the selected skill;
processing a relative input comprising (i) an initial observation in the sequence and (ii) a last observation in the sequence using a relative discriminator neural network that is configured to process the relative input to generate a relative output that includes a respective relative score corresponding to each skill in the set of skills, each relative score representing an estimated likelihood that the policy neural network was conditioned on the corresponding skill while the trajectory was generated;
processing an absolute input comprising the last observation in the sequence using an absolute discriminator neural network that is configured to process the absolute input to generate an absolute output that includes a respective absolute score corresponding to each skill in the set of skills, each absolute score representing an estimated likelihood that the policy neural network was conditioned on the corresponding skill while the trajectory was generated;
generating a reward for the trajectory from the absolute score corresponding to the selected skill and the relative score corresponding to the selected skill; and
training the policy neural network on the reward for the trajectory.

2. The method of claim 1, the operations further comprising:
training the absolute discriminator neural network to optimize an objective function that encourages the absolute score corresponding to the selected skill to be increased.

3. The method of claim 1, the operations further comprising:
training the relative discriminator neural network to optimize an objective function that encourages the relative score corresponding to the selected skill to be increased.

4. The method of claim 1, wherein the absolute discriminator neural network and the relative discriminator neural network share some parameters.

5. The method of claim 4, wherein the absolute discriminator neural network and the relative discriminator neural network share an encoder neural network that generates encoded representations of received observations.

6. The method of claim 5, wherein the absolute discriminator neural network comprises an absolute decoder neural network configured to process the encoded representation of the last observation to generate the absolute output.

7. The method of claim 5, wherein the relative discriminator neural network comprises a relative decoder neural network configured to process a concatenation of the encoded representations of the initial observation and the last observation to generate the relative output.

8. The method of claim 1, wherein training the policy neural network on the reward for the trajectory comprises training the neural network to maximize time discounted expected rewards for generated trajectories, and wherein:
the reward rewards high relative scores and penalizes high absolute scores.

9. The method of claim 8, wherein the reward is equal to or directly proportional to a difference between the relative score corresponding to the selected skill and the absolute score corresponding to the selected skill.

10. The method of claim 8, wherein the reward is equal to or directly proportional to a difference between a logarithm of the relative score corresponding to the selected skill and a logarithm of the absolute score corresponding to the selected skill.

11. The method of claim 1, wherein selecting a skill from the set of skills comprises:
sampling a skill from a uniform probability distribution over the set of skills.

12. The method of claim 1 wherein training the policy neural network on the reward for the trajectory comprises training the policy neural network through off-policy reinforcement learning.

13. The method of claim 1, wherein generating the trajectory comprises generating the trajectory starting from a last state of the environment for a preceding trajectory, and wherein the initial observation characterizes the last state of the environment for the preceding trajectory.

14. The method of claim 13, the operations further comprising:
after generating the trajectory, determining whether criteria have been satisfied for resetting the environment; and
in response to determining that the criteria are satisfied, selecting, as an initial state for a next trajectory to be generated, a state of the environment from a set of possible initial states of the environment.

15. (canceled)

16. One or more non-transitory computer-readable storage media encoded with instructions that, when executed by one or more computers, cause the one or more computers to perform first operations for training a policy neural network for use in controlling an agent interacting with an environment, wherein the policy neural network is configured to receive a policy input comprising an input observation characterizing a state of the environment and data identifying a skill from a set of skills and to generate a policy output that defines a control policy for controlling the agent, the first operations comprising repeatedly performing second operations comprising:
selecting a skill from the set of skills;
generating a trajectory by controlling the agent using the policy neural network while the policy neural network is conditioned on the selected skill, the trajectory comprising a sequence of observations received while the agent interacts with the environment while controlled using the policy neural network that is conditioned on the selected skill;
processing a relative input comprising (i) an initial observation in the sequence and (ii) a last observation in the sequence using a relative discriminator neural network that is configured to process the relative input to generate a relative output that includes a respective relative score corresponding to each skill in the set of skills, each relative score representing an estimated likelihood that the policy neural network was conditioned on the corresponding skill while the trajectory was generated;
processing an absolute input comprising the last observation in the sequence using an absolute discriminator neural network that is configured to process the absolute input to generate an absolute output that includes a respective absolute score corresponding to each skill in the set of skills, each absolute score representing an estimated likelihood that the policy neural network was conditioned on the corresponding skill while the trajectory was generated;
generating a reward for the trajectory from the absolute score corresponding to the selected skill and the relative score corresponding to the selected skill; and
training the policy neural network on the reward for the trajectory.

17. A system comprising one or more computers and one or more storage devices storing instructions that are operable, when executed by the one or more computers, to cause the one or more computers to perform first operations for training a policy neural network for use in controlling an agent interacting with an environment, wherein the policy neural network is configured to receive a policy input comprising an input observation characterizing a state of the environment and data identifying a skill from a set of skills and to generate a policy output that defines a control policy for controlling the agent, the first operations comprising repeatedly performing second operations comprising:
selecting a skill from the set of skills;
generating a trajectory by controlling the agent using the policy neural network while the policy neural network is conditioned on the selected skill, the trajectory comprising a sequence of observations received while the agent interacts with the environment while controlled using the policy neural network that is conditioned on the selected skill;
processing a relative input comprising (i) an initial observation in the sequence and (ii) a last observation in the sequence using a relative discriminator neural network that is configured to process the relative input to generate a relative output that includes a respective relative score corresponding to each skill in the set of skills, each relative score representing an estimated likelihood that the policy neural network was conditioned on the corresponding skill while the trajectory was generated;
processing an absolute input comprising the last observation in the sequence using an absolute discriminator neural network that is configured to process the absolute input to generate an absolute output that includes a respective absolute score corresponding to each skill in the set of skills, each absolute score representing an estimated likelihood that the policy neural network was conditioned on the corresponding skill while the trajectory was generated;
generating a reward for the trajectory from the absolute score corresponding to the selected skill and the relative score corresponding to the selected skill; and
training the policy neural network on the reward for the trajectory.

18. The system of claim 17, the second operations further comprising:
training the absolute discriminator neural network to optimize an objective function that encourages the absolute score corresponding to the selected skill to be increased.

19. The system of claim 17, the second operations further comprising:
training the relative discriminator neural network to optimize an objective function that encourages the relative score corresponding to the selected skill to be increased.

20. The system of claim 17, wherein the absolute discriminator neural network and the relative discriminator neural network share some parameters.

21. The system of claim 20, wherein the absolute discriminator neural network and the relative discriminator neural network share an encoder neural network that generates encoded representations of received observations.
